(19) United States
(12) Patent Application Publication
(10) Pub. No.: US 2007/0067535 A1
(43) Pub. Date: Mar. 22, 2007

(54) MOTHERBOARD CAPABLE OF SELECTIVELY SUPPORTING DUAL GRAPHIC ENGINE

(76) Inventor: Ta-Wei Liu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,691

(22) Filed: Sep. 20, 2005

(51) Int. Cl. G06F 13/00

(52) U.S. Cl. 710/300

(57) ABSTRACT

A motherboard includes a north bridge circuit, a central processing unit (CPU) socket coupled to the north bridge circuit through a hypertransport bus; a first slot coupled to the north bridge circuit; and an upgrade slot, coupled to the second slot and the hypertransport bus, for installing a removable tunnel module. When the removable tunnel module is installed inside the upgrade slot, the motherboard is capable of supporting a computer component installed inside the second slot.

### BACKGROUND OF THE INVENTION

1. Field of Invention

The present invention relates to a mother board. More particularly, the present invention relates to a motherboard capable of selectively supporting dual graphic engine.

2. Description of Related Art

With continuous development of computer technology, theoretically, bandwidth of data communication usually increases in proportional to wide development of speed of data communication, so as to raise the whole performance of computer speed. As for data communication, bottleneck of bandwidth always occurs between the north bridge chip and the south bridge chip. Therefore, a communication method of so-called hypertransport protocol has been developed by the industries to solve above problems by providing a higher communication bandwidth between the north bridge chip and the south bridge chip.

Broadly speaking, hypertransport technology is a packet-based protocol. Basically, the hypertransport technology is an interface of protocol rather than physical. The hypertransport technology can be upgraded according to a new application program. In the hypertransport protocol, data are cut into packets or blocks of 64 bytes in maximum. In other words, computer components can transfer data, like packet, by the manner of point to point, via the hypertransport technology, so that the computer components can interconnect and communicate mutually. The communication bandwidth can be up to 12.8 GB. Besides, only is one hypertransport tunnel needed under hypertransport construction, then a connection to the other computer components can be easily done. For example, the computer can serve as a dual-CPU computer when the computer couples with another CPU.

FIG. 1 is a diagram, schematically showing the conventional device under hypertransport construction. As shown in FIG. 1, a hypertransport host 100 is coupled to a hypertransport peripheral 120 by a hypertransport bus 110, which includes a hypertransport tunnel 130. Therefore, the hypertransport host 100 can be coupled to another hypertransport peripheral 140 by the hypertransport tunnel 130. For example, the hypertransport host 100 can be a CPU, the hypertransport peripheral 120 can be a north bridge circuit and the hypertransport peripheral 140 can be a graphic card (certainly, as shown above, another CPU can be added). Then, it can be understood that the whole computer system can additionally support a graphic card (or CPU) between the north bridge circuit and the CPU.

FIG. 2 is a functional block diagram, schematically showing a motherboard 200 utilizing hypertransport technology of FIG. 1. As shown in FIG. 2, the motherboard 200 includes a CPU socket 210, a north bridge circuit 220, a south bridge circuit 230, a tunnel chip 240, a hypertransport bus 250 and graphic card sockets 260, 270. Here, it is assumed that the CPU socket 210 is a 939/754 CPU and the CPU socket 210 is coupled to the north bridge circuit 220 by aforesaid hypertransport bus 250. Besides, the tunnel chip 240 is used to connect to a path of the hypertransport bus 250 so that the motherboard 200 can support graphic card, installed in the graphic card socket 260. As general known by the manufacturers, the graphic card socket 270 is coupled to the north bridge circuit 220 so that motherboard 200 can support the graphic card installed in the graphic card socket 270. In other words, the motherboard 200 can support dual graphic card because of tunnel chip 240. Here, please note that the south bridge circuit 230 is coupled to the north bridge circuit 220, the function of the south bridge circuit 230 and the north bridge circuit 220, such as the signal transferring, should known in the ordinary skill art, and is not further described. Besides, the motherboard 200 can include a memory socket, audio card and so on (not shown in FIG. 2) which are not described herein for simple descriptions.

Aforesaid motherboard 200 can support dual graphic card at the same time. However, for the users without need of this function, the built-in tunnel chip 240 may waste resource and cost. In other aspect, users may only buy a usual motherboard that only supports a single graphic card. When the computer system is developed up to a certain level, many software or display need two graphic cards to drive. As a result, the users must additionally buy a motherboard that supports dual graphic cards. Obviously, it's not an economical solution.

### SUMMARY OF THE INVENTION

Therefore, the primary objective of the present invention is to provide motherboard capable of selectively support dual graphic card to solve prior issues.

According to claims of the present invention which discloses a motherboard, the mother board includes a north bridge circuit, a central processing unit (CPU) socket coupled to the north bridge circuit through a hypertransport bus; a first slot coupled to the north bridge circuit; a second slot; and an upgrade slot, coupled to the second slot and the hypertransport bus, for installing a removable tunnel module. Wherein, when the removable tunnel module is installed inside the upgrade slot, the motherboard is capable of supporting a computer component installed inside the second slot.

According to claims of the present invention which discloses a motherboard, the motherboard includes a north bridge circuit, a south bridge circuit coupled to the north bridge circuit through a hypertransport bus; a first slot coupled to the north bridge circuit; a second slot; and an upgrade slot, coupled to the second slot and the hypertransport bus, for installing a removable tunnel module. When the removable tunnel module is installed inside the upgrade slot, the motherboard is capable of supporting a computer component installed inside the second slot.

The motherboard of the present invention includes an upgrade socket which is used to install a removable tunnel module so that the motherboard can support the graphic card installed in the graphic card socket while the removable tunnel module installed inside the upgrade socket and the motherboard cannot support the graphic card installed in the graphic card socket while the removable tunnel module doesn't be installed inside the upgrade socket. Therefore, the motherboard of the present invention can selectively support dual graphic cards or single graphic card depend on users' favor. In other words, the users need only to install removable tunnel module to upgrade the motherboard while the users need the dual graphic cards to provide high display performance for the purpose of two graphic cards. Therefore, the motherboard of the present invention can not only save users' cost, but also provide another choice of display performance for the users.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram, schematically showing the conventional device under hypertransport construction.

FIG. 2 is a diagram, schematically showing a functional block diagram of a motherboard utilizing hypertransport technology of FIG. 1.

FIG. 3 is a diagram, schematically showing the motherboard, according to a first embodiment of the present invention.

FIG. 4 is a diagram, schematically showing a motherboard comprising removable tunnel module of FIG. 3.

FIG. 5 is a diagram, schematically showing the motherboard, according to a second embodiment of the motherboard.

FIG. 6 is a diagram, schematically showing the motherboard with removable tunnel module of FIG. 5.

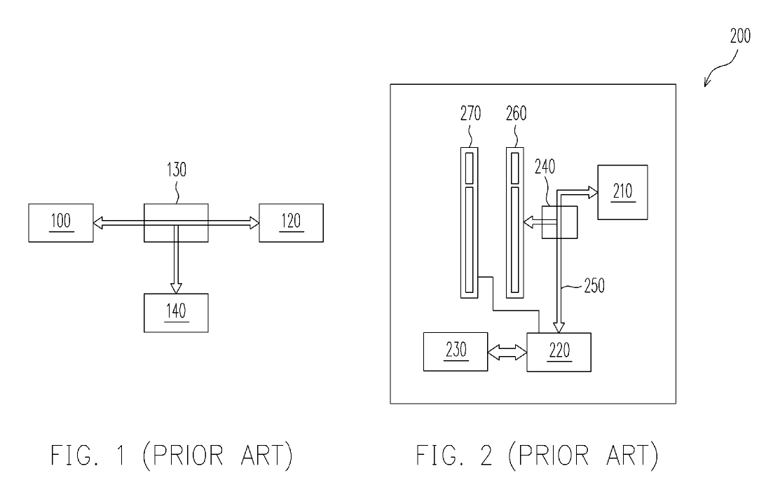

### DESCRIPTION OF THE PREFERRED EMBODIMENTS

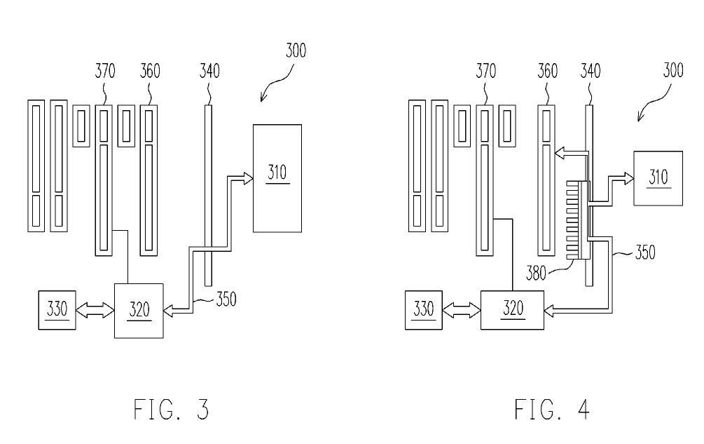

FIG. 3 is a diagram, schematically showing a motherboard 300, according to a first embodiments of the present invention. As shown in FIG. 3, the motherboard 300 also includes a CPU socket 310, a north bridge circuit 320, a south bridge circuit 330, a hypertransport bus 330, a hypertransport 350 and graphic card sockets 360 and 370. Their functions are not described here for those having the same components as the components of FIG. 2. For example, in the present embodiments, the CPU socket 310 can be a 939/754 CPU socket so that the CPU socket 310 is coupled to the north bridge circuit 320 by the hypertransport bus 350.

Here, please note that the motherboard 300 further includes an upgrade socket 340, coupled to the graphic card socket 360 and the hypertransport bus 350. The upgrade socket 340 is used to install a removable tunnel module, for example, the removable tunnel module can be an interface card including aforesaid tunnel chips. Thus, the motherboard can support the graphic card installed in the graphic card socket by the tunnel chip on the interface card while the removable tunnel module installed inside the upgrade socket and the motherboard cannot support the graphic card installed in the graphic card socket while the removable tunnel module doesn't install inside the upgrade socket. For example, as shown in FIG. 3, communications of the CPU socket 310 and the north bridge circuit 320 is done by communicating directly through the hypertransport bus 350 and the upgrade socket 340 while the motherboard doesn't include the removable tunnel module.

FIG. 4 is a diagram, schematically showing a motherboard 300 including the removable tunnel module of FIG. 3. As shown in FIG. 4, signals between the graphic card socket 360 and the north bridge circuit 320 or the CPU socket 310 may transmit to the hypertransport bus 350 by the removable tunnel module 380 while the upgrade socket 340 installs the removable tunnel module 380. Therefore, in addition to the original graphic card socket 370 supported by the north bridge circuit 320, the motherboard 300 can further support the graphic card socket 360, in operation of supporting a dual-graphic-card.

FIG. 5 is a diagram, schematically showing a motherboard 500, according to a second embodiment of the present invention. As shown in FIG. 5, the motherboard 500 also comprises a CPU socket 510, a north bridge circuit 520, a south bridge circuit 530, a hypertransport bus 550 and graphic card sockets 560 and 570. Their functions won't describe here for those the same components as the components of FIG. 2. However, please note that herein the CPU socket 510 is a 775 CPU socket, which means that the CPU socket 510 is coupled to the north bridge circuit 520 by a front side bus (FSB ) 590 rather than an original hypertransport bus.

However, in the present embodiment, the north bridge circuit 520 and the south bridge circuit 530 are coupled mutually by a hypertransport bus 550. Therefore, as described above, by using the characteristics of the upgrade socket and the removable tunnel module, hypertransport bus 550 can be used. As shown in FIG. 5, the motherboard 500 further includes an upgrade socket 540 coupled to the graphic card socket 360 and the hypertransport bus 350. Similarly, the upgrade socket 540 can install a removable tunnel module so that the motherboard can support the graphic card installed in the graphic card socket while the removable tunnel module installed in the upgrade socket.

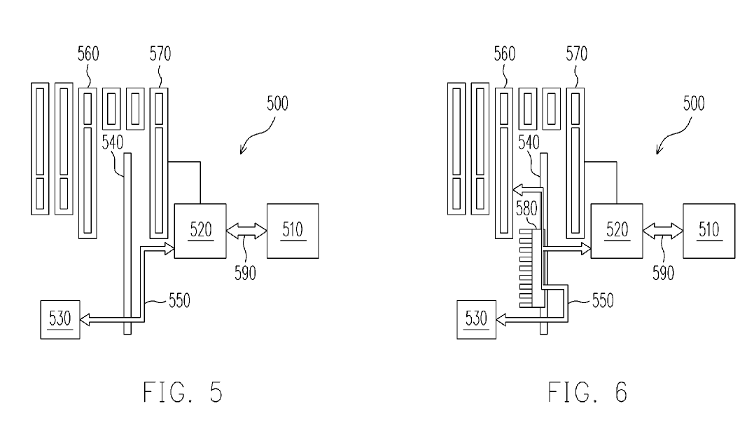

As shown in FIG. 5, the north bridge circuit 520 and the south bridge circuit 530 transmit signals through the hypertransport bus 550 and the upgrade socket 540 while the motherboard doesn't comprise a removable tunnel module. And please refer to FIG. 6, which is a diagram, schematically showing the motherboard 500 with the removable tunnel module 580 of FIG. 5. As shown in FIG. 6, signals between the graphic card socket 560 and the north bridge circuit 520 or the south bridge circuit 530 may transmit to the hypertransport bus 350 by the removable tunnel module 580 while the upgrade socket 540 installs the removable tunnel module 580. Therefore, in addition to the original graphic card socket 570 supported by the north bridge circuit 520, the motherboard 500 can further support the graphic card socket 560 so as to be one that supports dual graphic cards.

Here please note that the present invention is not restricted to the types of graphic cards necessary to install in the graphic card sockets 360, 370, 560, 570. In other words, aforesaid graphic card sockets 360, 370, 560, 570 can install different kinds of graphic cards. For example, the graphic card sockets 360, 370, 560, 570 can install PCI Express (such as PCI 16) graphic card or general AGP graphic card. Such corresponding modifications shall be within the scope of the present invention.

Additionally, types of upgrade sockets 340, 350 are also not restricted in the present invention. In other words, the upgrade socket may be practiced by all kinds of sockets such as AGP socket and so on that possesses necessary pins to couple to graphic card sockets 360, 560 to support subsequent data transmission of hypertransport bus. Such corresponding modifications are also within the scope of the present invention.

Comparing the present invention with prior arts, the motherboard of the present invention comprises an upgrade socket which is used to install a removable tunnel module so that the motherboard can support the computer components installed in the second socket while the removable tunnel module installed inside the upgrade socket and the motherboard doesn't support the computer components installed in the second socket while the removable tunnel module doesn't install inside the upgrade socket. Therefore, the motherboard of the present invention may selectively support dual graphic card or single graphic card by users' preference. In other words, the users need only to install the removable tunnel module to upgrade the motherboard if it is needed to use dual graphic card to provide higher display performance to achieve the goal of dual graphic card. Therefore, the motherboard of the invention not only can save users' cost, but also can provide another choice of display performance for users.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A motherboard, comprising:
a north bridge circuit;
a CPU socket, coupled to the north bridge circuit by a hypertransport bus;
a first socket, coupled to the north bridge circuit;
a second socket, and an upgrade socket, coupled to the second socket and the hypertransport bus, used to install a removable tunnel module, wherein the motherboard can support a plurality of computer components installed by the second socket while the removable tunnel module installed in the upgrade socket.

2. A motherboard as claimed in claim 1, wherein the first and second sockets are graphic card sockets.

3. A motherboard as claimed in claim 1, wherein the first and second sockets are PCI Express sockets.

4. A motherboard as claimed in claim 3, wherein the first and second sockets are graphic card sockets.

5. A motherboard as claimed in claim 1, wherein the CPU socket is a 939/754 CPU socket.

6. A motherboard, comprising:
a north bridge circuit;
a south bridge circuit, coupled to the north bridge circuit by a hypertransport bus;
a first socket, coupled to the north bridge circuit;
a second socket, and an upgrade socket, coupled to the second socket and the hypertransport bus, used to install a removable tunnel module, wherein the motherboard can support a plurality of computer components installed in the second socket while the removable tunnel module installed in the upgrade socket.

7. A motherboard as claimed in claim 6, wherein the first and second sockets are graphic card sockets.

8. A motherboard as claimed in claim 6, wherein the first and second sockets are PCI Express sockets.

9. A motherboard as claimed in claim 8, wherein the first and second sockets are graphic card sockets.
